(19) United States
(12) Patent Application Publication
(10) Pub. No.: US 2023/0017861 A1
(43) Pub. Date: Jan. 19, 2023

(54) VEST

(71) Applicant: Christian Geltenpoth, Nürnberg (DE)

(72) Inventor: Christian Geltenpoth, Nürnberg (DE)

(21) Appl. No.: 17/866,660

(22) Filed: Jul. 18, 2022

(30) Foreign Application Priority Data
Jul. 19, 2021 (DE) 102021118626.9

(51) Int. Cl. A41D 13/01; A41D 1/04; A41D 1/00

(52) U.S. Cl. CPC A41D 13/01; A41D 1/04; A41D 1/002

(57) ABSTRACT

The present invention relates to a vest (1), comprising a strap (2), which is characterized in that the strap (2) comprises a lockable lock (2.1).

The present invention relates to a vest and, in particular, a safety or warning vest, as it is worn, for example, when driving a two-wheeler (such as scooter, e-scooter, bicycle or motorcycle). Such vests can be easily put on over normal clothing and usually consist of a textile with a bright colour so that these vests are certainly easy to recognize. In addition, reflective elements are incorporated or attached to the vest. Thus, the wearers of the vests can be easily recognized at dusk and at night by passing road users.

From DE 20 2016 007 645 U1, a vest is known, which includes signal lights. However, the signal lights must be connected to the two-wheeler by means of a cable. In order for the signal lights to work, it must therefore be ensured that the vest is connected to the two-wheeler via the cable during operation. Care must also be taken to ensure that the driver disconnects the cable connection with the vest when getting off the two-wheeler.

In some countries, there are even efforts to make the wearing of such high-visibility vests mandatory when using a two-wheeler.

When using such a vest, there is also regularly the problem of how to handle the vest, whether it is carried, for example, for which a bag is usually needed.

The object of the present invention is therefore to simplify the handling of a vest and, in particular, the storage of a vest at the destination after driving a two-wheeler.

Another task is to improve the visibility of a driver of a two-wheeler and, in particular, to make the driver's behaviour more predictable for other road users.

The object is achieved by a vest with the features of independent claim 1.

The object is achieved by a vest with the features of independent claim 5.

Both solutions can also be implemented together in a vest, which makes a corresponding vest safe and versatile.

Favourable further embodiments of the vest are explained in the dependent claims and in the above and following description, wherein individual features of the advantageous further developments can be combined with each other in a technically meaningful manner.

It is already known that such vests have a strap for better fixation while driving, which has an element of a buckle at each of its ends so that the elements can be inserted into each other to fix the vest.

It is now proposed that the strap of the vest includes a lockable lock. Such a lockable lock may be formed, for example, as a combination lock, as a lockable lock by means of a key and/or as an electromechanical lock.

In this way, the vest or the strap of the vest can be used at the destination to connect the two-wheeler to a stationary object so that the function of the vest is enhanced.

The strap of the vest is attached, in particular, in a suitable way to the vest, in particular, being moveable. For example, the vest may have eyelets made of textile material through which the strap is passed. The vest may also have at least one channel formed by textile material, through which the strap is passed. For this purpose, for example, a textile material may be sewn onto the material forming the vest, wherein the seams on opposite sides of the sewn-on textile material are formed so that the channel being thereby formed is open on two sides. On the one hand, this ensures that the strap is arranged in a predetermined position when the vest is worn and, on the other hand, ensures that the textile material cannot be removed from the strap when connected.

With such a lockable lock, it is ensured that only the user who owns or knows the key can unlock the two-wheeler. Simultaneously, it is also ensured that the vest required for the further journey is located on the two-wheeler.

So that the strap in the strapped state can not be destroyed with simple means, in a preferred embodiment, it is provided that the strap consists of a cut-resistant textile, such as aramid for example. The strap is therefore preferably made of aramid fibres, which are also known under the brand name Kevlar.

The task is also achieved in that the vest comprises a signalling device and that the signalling device is set up to light up during a braking process, and that the signalling device formed on the vest has an acceleration sensor such as a giro-sensor for example.

With the acceleration sensor designed on the vest, an acceleration of the wearer of the vest and thus the two-wheeler can be detected independently of the two-wheeler. The acceleration sensor can, for example, be designed as a gyro sensor.

By illuminating the signalling device, the following road users are immediately signalled to the wearer of the vest that the state of movement of the wearer is changing, whereby the following traffic detects the braking process more quickly and thus the safety of the wearer is increased. The arrangement of this signalling device also has the advantage that the lamps indicating the braking process are arranged in an elevated position compared to the two-wheeler and are therefore more visible to the following road users.

The signalling device includes, in particular, red LEDs, which are arranged on a back side of the vest. The red LEDs can be arranged more or less arbitrarily on the back side of the vest. For example, the LEDs can be centrally fixed in a rectangular, circular or triangular arrangement on the back side of the vest. The LEDs can also be arranged in one or a plurality of strips on the back side of the vest.

In addition, it may also be provided that the signalling device comprises one or a plurality of white light-emitting LEDs, which are arranged, in particular, on the front side of the vest.

According to the invention, it is now proposed that at least a part of the signalling device lights up during a braking process, which in particular also includes that elements of the signalling device already operate before the braking process and shine brighter with the braking process. This includes, in particular, that the signalling device lights in a first state with a first intensity and lights at a second intensity during braking, wherein the second intensity is greater than the first intensity. The second intensity is in particular 20%, preferably at least 50% greater than the first intensity.

In particular, it is proposed that only the red LEDs light up during braking.

The acceleration sensor can also be used to detect any movement of the vest and thus of its wearer. In particular, it may be provided that when a movement is detected, the signalling device is switched on and the LEDs thus lights up in particular with a first intensity, while in a detected braking process (deceleration, which does not correspond to simply coasting) lights up.

The control system, which comprises the acceleration sensor, is set up in particular in such a way that, based on the data generated by the acceleration sensor, it is reliably detected whether the vest is in motion, is braking or is in a longer state of rest. If a state of rest is reliably detected, the power consumption of the signalling device is reduced. In particular, the controller contains a program for pattern recognition, by means of which non-relevant processes acceleration data are filtered out.

The invention as well as the technical environment are explained in the following on the basis of the figures in an exemplary manner. The figures show schematically

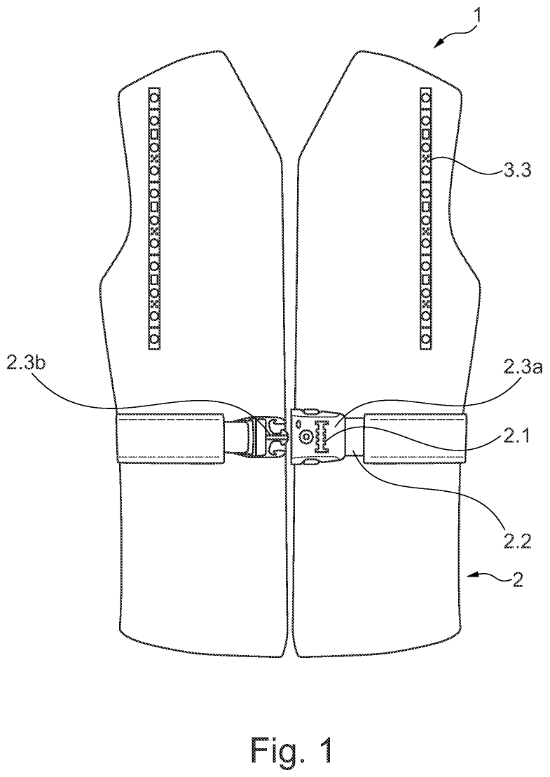

FIG. 1: a front view of a vest,

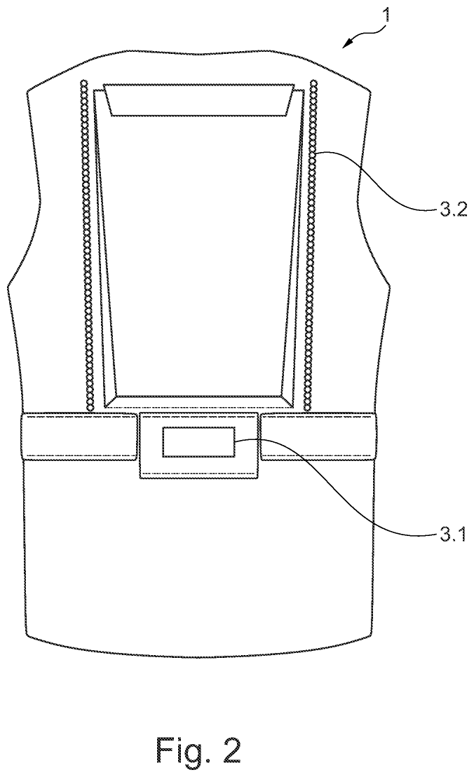

FIG. 2: a rear view of a vest and

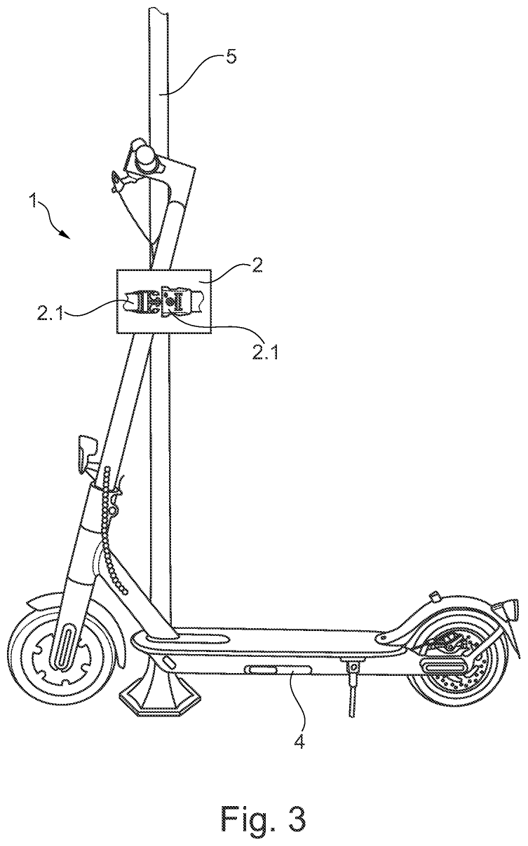

FIG. 3: the vest in a state adjacent to a two-wheeler on an object.

The vest 1 shown in the figures has a strap 2, whose webbing 2.2 is passed through a channel in the vest. At the ends of the webbing 2.2 a lock part 2.1a and 2.1b of a lockable lock is attached.

The lock part 2.2 can be plugged into the lock part 2.1, wherein the loosening of the lock part 2.1 can be prevented by means of a locking device that can be operated by means of a key or a combination of numbers.

On the front side of the vest 1 visible in FIG. 1, white luminous LEDs 3.1 of a signalling device 3 are attached. On the back side of vest 1 visible in FIG. 2, two stripes of red LEDs 3.2 are attached. LEDs 3.2 and 3.3 are connected to a control system comprising an acceleration sensor 3.1. The control is set up in such a way that both LEDs 3.2 and 3.3 light up when a moving carrier of the vest 1 is detected. If a braking operation of a wearer of the vest 1 is detected by means of the acceleration sensor 3.1, the red LEDs 3.2 light up with a higher intensity. The road users following the wearer of the vest 1 are thus visually informed of the braking process.

The webbing 2.2 of the strap 2 is made of a cut-resistant material such as aramid fibres for example. When the wearer of the vest 1 has reached his destination, he/she can roll up the vest in a suitable manner and use the strap 2 to connect the two-wheeler to a stationary object, as shown in FIG. 3.

The vest 1 thus fulfils a plurality of functions. On the one hand, it warns the following road users against braking the wearer of the vest and on the other hand, it can be used at the destination to secure the two-wheeler against theft.

### REFERENCE LIST

1 vest

2 strap

2.1 lock

2.1a lock part

2.1b lock part

2.2 webbing

3 signalling device

3.1 acceleration sensor

3.2 LED

3.3 LED

1. Vest (1), comprising a signalling device (3), wherein the signalling device (3) is set up to light up during braking, characterized in that the signalling device (3) comprises an acceleration sensor (3.1).

2. Vest (1) according to claim 1, wherein the signalling device (3) glows in a first state with a first intensity and glows in a braking process with a second intensity, wherein the second intensity is greater than the first intensity.

3. Vest (1) according to claim 1, wherein the signalling device (3) comprises at least one red light-emitting LED (3.2) which light up during braking.

4. Vest (1) according to claim 3, wherein the signalling device (3) comprises at least one white light-emitting LED (3.3) which do not light up during braking.

5. Vest (1) according to claim 1, further comprising a strap (2), characterized in that the strap (2) comprises a lockable lock (2.1).

6. Vest (1) according to claim 5, wherein the lock (2.1) comprises a combination lock, a lockable lock by means of a key and/or an electromechanical lock.

7. Vest (1) according to claim 5, wherein a webbing (2.2) of the strap (2) comprises a cut-resistant textile, such as aramid for example.

8. Use of a vest (1) comprising a strap (2) with a lockable lock (2.1), in particular, a vest (1) according to a claim referring back to claim 5 for connecting a two-wheeler to a fixed object.
